(19) United States
(12) Patent Application Publication
(10) Pub. No.: US 2026/0055934 A1
(43) Pub. Date: Feb. 26, 2026

(54) Thermoacoustic device

(71) Applicant: Nederlandse Organisatie voor toegepast-natuurwetenschappelijk Onderzoek TNO, 's-Gravenhage (NL)

(72) Inventors: Moulay EL Hassan Tijani, Petten (NL); Jan Aiso Lijcklama à Nijeholt, Petten (NL)

(73) Assignee: Nederlandse Organisatie voor toegepast-natuurwetenschappelijk Onderzoek TNO, 's-Gravenhage (NL)

(21) Appl. No.: 19/378,751

(22) Filed: Nov. 4, 2025

Related U.S. Application Data
(63) Continuation-in-part of application No. 18/648,576, filed on Apr. 29, 2024.
Application No. 18/648,576 is a continuation of application No. 17/766,774, now Pat. No. 12,000,641.

(30) Foreign Application Priority Data
Oct. 8, 2019 (EP) 19202020.4

(51) Int. Cl. F25B 9/14; F02G 1/043

(52) U.S. Cl. CPC F25B 9/145; F02G 1/043; F25B 2309/1402; F25B 2309/1405; F25B 2309/1409

(57) ABSTRACT

A thermoacoustic device includes a process volume which is filled with a working fluid through which the acoustic wave propagates. The thermoacoustic device further includes an acoustic network comprising a tubular loop configured with a passage providing an opening in the loop and configured as acoustic circuit provided with a compliance volume, a thermo-acoustic core and an inertance volume. Within the loop, the thermoacoustic core is at a first side thereof adjacent to the passage at a first path length through the loop, and at its second side, opposite to the first side, the thermoacoustic core is at a second path length from the passage.

The thermoacoustic device includes within the loop a spring-type partitioning element that is configured to close off the cross-section of the tube and to be impermeable for the working fluid while allowing transmission of pressure waves in the working fluid through the spring-type partitioning element.

### FIELD OF THE INVENTION

The present invention relates to a thermoacoustic device. Also, the invention relates to a method for manufacturing such a thermoacoustic device.

### BACKGROUND

A traveling wave thermoacoustic device consists in general of a regenerator unit or thermoacoustic core, comprising a regenerator and two heat exchangers, a feedback loop, and a pressure vessel holding a gas volume and that houses all components. The regenerator is arranged between the two heat exchangers. The heat exchangers are configured to transfer heat to or from the thermoacoustic device. Within the thermoacoustic device a conversion process between acoustic power and thermal power, and vice versa, takes place in the regenerator. A thermoacoustic device can be configured as an engine or as a heat pump.

The performance of such a thermoacoustic device can be characterized by two parameters: efficiency of the conversion process and power density. An ideal thermoacoustic device has both a high efficiency and a high power density. However, this combination is not always feasible.

Acoustic power is amplified or attenuated by a temperature ratio across the regenerator unit generated by a temperature difference between the two heat exchangers. In addition, an acoustic circuit is provided within the thermoacoustic device, which is characterized by a compliance and an inertance (feedback inertance).

A highest efficiency for the conversion in the thermoacoustic device can be obtained with a high resistance at the regenerator unit, which results in low gas velocities in the regenerator unit (low flow losses) and a small phase difference (about) 0° between velocity and pressure of the gas flowing through the regenerator unit. In order to obtain this traveling wave phasing, the magnitude of an impedance of the gas in the feedback inertance should be small compared to the resistance at the regenerator unit.

The power of the thermoacoustic device is controlled by a velocity of gas through the regenerator unit, while keeping all other parameters constant (geometry, average pressure, drive ratio, frequency, working medium). Increasing the compliance of the gas volume will lead to higher volume velocities but also to larger power losses. In fact, acoustic losses in the regenerator are proportional to the square of the velocity of the gas.

The preferred solution would be a thermoacoustic system with high volume velocities through the regenerator unit, without compromising the efficiency too much. In addition, the solution should not lead to prohibitively large costs associated with large gas volumes or large components.

U.S. Pat. No. 6,032,464 describes a traveling-wave device that is provided with the conventional moving pistons eliminated. Acoustic energy circulates in a direction through a fluid within a torus. A side branch may be connected to the torus for transferring acoustic energy into or out of the torus. A regenerator is located in the torus with a first heat exchanger located on a first side of the regenerator downstream of the regenerator relative to the direction of the circulating acoustic energy; and a second heat exchanger located on an upstream side of the regenerator. A mass flux suppressor is located in the torus to minimize time-averaged mass flux of the fluid.

It is an object of the present invention to overcome or mitigate one or more e disadvantages from the prior art.

### SUMMARY OF THE INVENTION

The object is achieved by a thermoacoustic device for transfer of energy by an acoustic wave, comprising a process volume, the process volume being filled with a working fluid through which the acoustic wave propagates, comprising: an acoustic network comprising a loop configured with a passage; the loop being a tube configured as acoustic circuit provided with a compliance volume, an inertance volume, and a thermoacoustic core; the passage providing an opening in the loop spaced apart from the thermoacoustic core, wherein the loop connects the thermoacoustic core and the passage via two separate paths; wherein a first side of the thermoacoustic core is at a first path length from the passage in one of the two paths, and a second side of the thermoacoustic core is at a second path length in the other of the two paths;

wherein the thermoacoustic device comprises a spring-type partitioning element within the loop; the spring-type partitioning element being configured to close off the cross-section of the tube and to be impermeable for the working fluid while allowing transmission of pressure waves in the working fluid through the spring-type partitioning element.

According to the invention, a spring-type partitioning element, i.e., a partition comprising an element with mechanical properties defined by a spring constant thereof, hereafter referred to as a (elastic or mechanical) spring is placed in the acoustic circuit near the thermoacoustic core (or regenerator unit). The spring enforces larger volume flows through the regenerator without adding gas volume to the system. The position of the spring-type partitioning element should be near the thermoacoustic core to be effective. Besides increasing the volume velocities and therewith power density, the spring-type partitioning element also improves the phasing between pressure and velocity of the gas in the regenerator and therefore has a beneficial effect on the efficiency as well. The spring-type partitioning element can also be used to suppress DC flow in the travelling wave engine or heat pump. Therefore, a jet pump or membrane can be omitted which will simplify the system and lower its costs. Convective heat losses in the thermal buffer tube of an engine or heat pump will be lowered by the additional thermal resistance of the partitioning element. This will lead to a further increase of the system efficiency.

It has to be understood that the spring element can be any type of spring; including cylindrical spring, conical spring, wave spring, flexure bearing, or any type of elastic membrane.

The present invention also relates to a method for manufacturing a thermoacoustic device in accordance with the following claims.

Advantageous embodiments are further defined by the dependent claims.

### BRIEF DESCRIPTION OF DRAWINGS

The invention will be explained in more detail below with reference to drawings in which illustrative embodiments thereof are shown. The drawings are intended exclusively for illustrative purposes and not as a restriction of the inventive concept. The scope of the invention is only limited by the definitions presented in the appended claims.

FIG. 1 shows a cross-section of a thermoacoustic device in accordance with the prior art;

FIG. 2 shows an impedance analogy of the thermoacoustic device in accordance with the prior art;

FIG. 3 shows a cross-section of a thermoacoustic device according to an embodiment of the invention;

FIG. 4A shows an impedance analogy of the thermoacoustic device of FIG. 3;

FIG. 4B shows a further impedance analogy of the thermoacoustic device of FIG. 3;

FIG. 5 shows a cross-section of a thermoacoustic device according to an embodiment of the invention;

FIG. 6 shows a cross-section of a spring-type partitioning element in accordance with an embodiment of the invention;

FIG. 7 shows a cross-section of a spring-type partitioning element in accordance with an embodiment of the invention;

FIG. 8 shows a cross-section of a spring-type partitioning element consisting of a thin plate in accordance with an embodiment of the invention.

### DETAILED DESCRIPTION OF EMBODIMENTS

FIG. 1 shows a cross-section of the thermoacoustic device in accordance with the prior art.

The thermoacoustic device 100 according to the prior art comprises a resonance tube 2 that is configured at one connecting end or passage 4 with a loop shaped tube or loop 6. Within the loop a thermoacoustic core 8 is arranged. At the connecting end the resonance tube 2 branches into a first leg 10 and second leg 12 that extend to a first side 8a and a second side 8b of the thermoacoustic core 8, respectively. The thermoacoustic core 8 is positioned “off-center in the loop”, i.e., the loop connects the thermoacoustic core 8 and the passage 4 via two separate paths: the first side 8a of the thermoacoustic core 8 is arranged at an end of the first leg 10 at a first path length L1 (indicated by dashed line) between the thermoacoustic core 8 and the connecting passage 4. The second side 8b of the thermoacoustic core 8 is arranged at an end of the second leg 12 at a second path length L2 (indicated by dashed line) between the thermoacoustic core 8 and the connecting passage 4.

The loop 6 acts as an acoustic circuit with a process volume V which is filled with a working fluid, for example a pressurized gas such as helium. The working pressure can be about 5 MPa (50 atm), for example.

Within the acoustic circuit, in the second leg 12 adjacent to the thermoacoustic core 8 a compliance volume 14 and an inertance volume (or: inertance tube) 16 are defined as explained above. The compliance volume 14 is defined to be positioned between the thermoacoustic core 8 and the inertance volume 16.

Typically, the thermoacoustic core 8 comprises a cold heat exchanger 8c, a regenerator 8d, and a hot heat exchanger 8e. The skilled in the art will appreciate that in the drawing the case of a heat pump is depicted. In case of an acoustic engine the position of the hot and cold heat exchangers is reversed. In this regard, “cold heat exchanger” and “hot heat exchanger” refer to the relative temperature of the respective heat exchangers during use: in use, the cold heat exchanger will have a lower temperature than the temperature of the hot heat exchanger.

The thermoacoustic core 8 may be part of either a thermoacoustic engine configuration, a thermoacoustic heat pump configuration, or a thermoacoustic cooler configuration.

The regenerator 8d is placed between the cold heat exchanger 8c and the hot heat exchanger 8e. Next to the hot heat exchanger 8e on a second side facing away from the regenerator unit 8d, a thermal buffer zone (not shown) may be arranged.

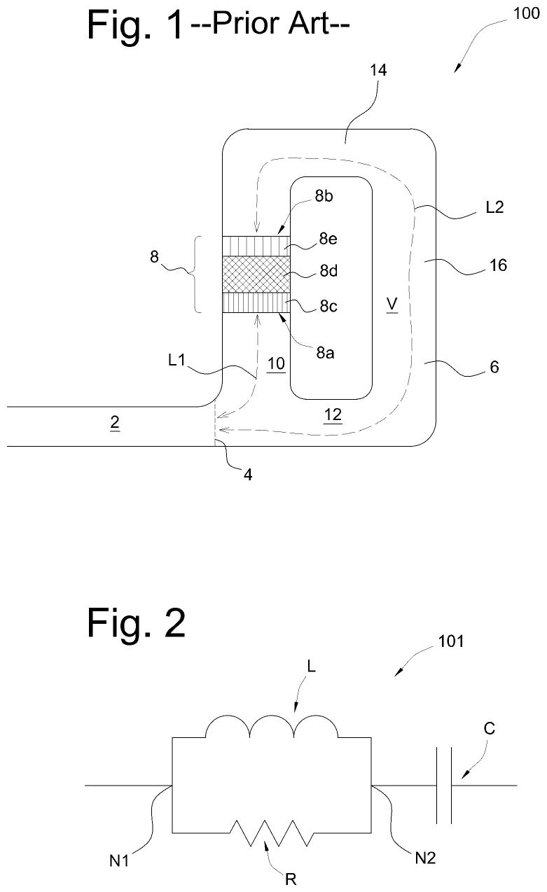

FIG. 2 shows an impedance analogy of a prior art thermoacoustic device 100 in accordance with FIG. 1.

In its simplest form, a traveling wave thermoacoustic device 100 as explained with reference to FIG. 1 is visualized by its impedance analogy 101 which schematically shows an electric network.

The electric network comprises a resistance R, an inductance L and a capacitance C.

The regenerator unit of the thermoacoustic device is characterized mainly by the resistance R. The compliance and the inertance of the gas volume are characterized by a capacitance C and an inductance L, respectively.

The resistance R is arranged in parallel with the inductance L between a first node N1 and a second node N2 in the network. The parallel combination of the resistance R and the inductance L is connected in series with the capacitance C at the second node N2.

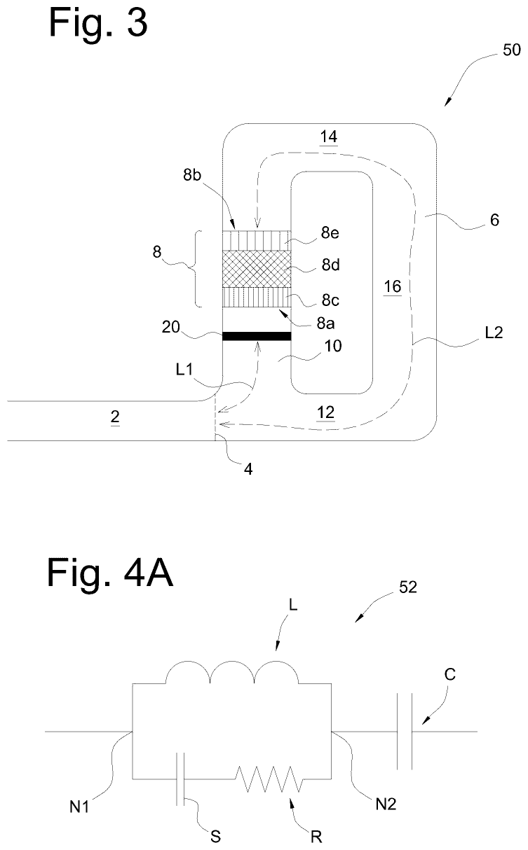

FIG. 3 shows a cross-section of a thermoacoustic device 50 according to an embodiment of the invention.

In FIG. 3 entities with the same reference number as shown in the preceding FIGS. 1-2 refer to corresponding or similar entities.

The thermoacoustic device 100 according to the invention comprises a loop shaped tube or loop 6 that is configured with an opening or passage 4. Within the loop a thermoacoustic core 8 is arranged. At the passage 4 the connecting tube 2 branches into a first leg 10 and second leg 12 that extend to a first side 8a and a second side 8b of the thermoacoustic core 8. A structure (not shown) is connected to the loop via the connecting tube 2. The thermoacoustic core 8 is positioned “off-center in the loop”, i.e., the loop connects the thermoacoustic core 8 and the passage 4 via two separate paths: the first side 8a of the thermoacoustic core 8 is arranged at an end of the first leg 10 at a first path length L1 between the thermoacoustic core 8 and the connecting passage 4. The second side 8b of the thermoacoustic core 8 is arranged at an end of the second leg 12 at a second path length L2 between the thermoacoustic core and the connecting passage 4.

In this arrangement, the first path length L1 is relatively shorter than the second path length L2. Optionally, the first path length L1 substantially corresponds to the second path length L2.

The structure that is connected to the loop may comprise a resonance tube, or a resonator equipped with a driver, for example a mechanical driver such a piston, mass-spring mechanical resonator or a piston compressor.

In this embodiment, the thermoacoustic device 50 is similar to the thermoacoustic device 100 as shown in FIG. 1, but additionally comprises a spring-type partitioning element 20 that is arranged within the first leg 10 of the loop 6 between the thermoacoustic core 8 and the connecting passage 4. The spring-type partitioning element 20 is configured to block flow of gas through the element 20. In other words, the spring-type partitioning element 20 is designed to be impermeable for gas. In addition, the spring-type partitioning element 20 has mechanical properties in accordance with a spring element to allow transmission of pressure waves through the element 20.

As a result, the spring-type partitioning element 20 is configured to enforce relatively larger volume flows through the regenerator 8 without adding gas volume to the device in comparison with the thermoacoustic device 100 according to the prior art. Besides increasing the volume velocities and therewith power density, the spring-type partitioning element 20 also improves the phasing between pressure and velocity and therefore has a beneficial effect on the efficiency as well.

Advantageously, the application of a spring-type partitioning element 20 results in a thermoacoustic device 50 that can be kept compact, has a relatively higher power density and improved efficiency.

Also, the spring-type partitioning element provide that DC flow in the travelling wave engine or heat pump is suppressed. Convective heat losses in the thermal buffer zone will be lowered by the additional thermal resistance of the partitioning element.

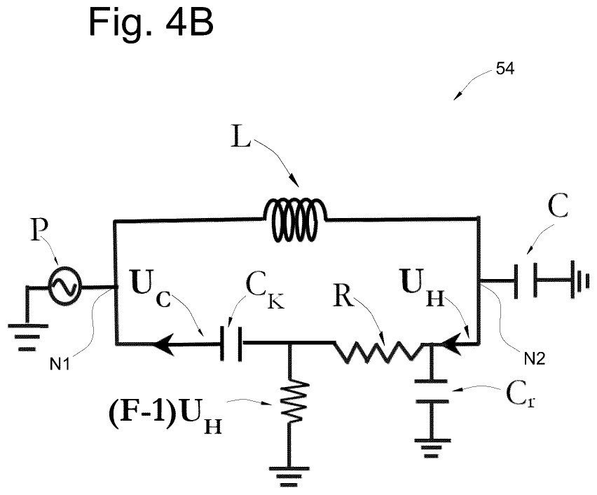

The impedance analogy of a possible implementation of the thermoacoustic device 50 according to the embodiment of FIG. 3 is illustrated in more detail with reference to FIG. 4.

FIG. 4A shows an impedance analogy 52 of the thermoacoustic device 50 of FIG. 3. In the impedance analogy the thermoacoustic device is visualized by a schematic electric network.

Similar to the electric network shown in FIG. 2, the electric network comprises a resistance R, an inductance L and a capacitance C, in which the resistance R corresponds with the resistance of the regenerator 8, the inductance L with the inertance volume 16 and the capacitance with the compliance volume 14, respectively. The resistance R is arranged in parallel with the inductance L between a first node N1 and a second node N2. The parallel combination of the resistance R and the inductance L is connected in series with the capacitance C at the second node N2.

According to the embodiment of the invention shown in FIG. 3, the impedance analogy additionally comprises a second capacitance S.

The second capacitance S is arranged in series with the resistance R, between the resistance R and the first node N1.

The second capacitance S at this position in the electric network corresponds with the compliance added by the spring-type partitioning element 20 in the first leg 10 of the loop 6.

FIG. 4B further illustrates a further impedance analogy 54 of the thermoacoustic device 50 of FIG. 3.

The second capacitance C_{K} of the electric network can be used to determine the compliance or spring constant of the partitioning element 20. The impedance analogy 52 representing the thermoacoustic device may produce a flow at the hot side of the regenerator, where the flow may be expressed by formula 1. The effect of the spring component C_{K} on the performance of the thermoacoustic heat pump can be demonstrated by comparing the electrical analog 101 in FIG. 2 of the heat pump 100 shown in FIG. 1 with the electrical analog 54 in FIG. 4B of the heat pump 50 shown in FIG. 3.

FIG. 4B shows that the heat pump is driven by a pressure source P like an oscillating piston. The acoustic components of the heat pump are represented by their electrical analogues in the circuit. The compliance is represented by the capacitance C. The inertance is represented by the induction L. The regenerator is represented by the flow resistance R and the capacitance Cᵣ, and a flow sink U_{H} determined by the temperature ratio across the regenerator. The spring component is represented by the capacitance C_{K} which is placed at the cold side of the regenerator. The capacitance C_{K} is the electric analog of the spring constant which is given by A²/K, where A is the cross section of a partitioning element determined by the equation A=πD²/4 where D is the diameter of the partitioning element, and K is the spring constant. U_{H} is the acoustic flow at the hot side of the regenerator and U_{C} is the acoustic flow at the cold side of the regenerator. For the electric analogy the acoustic flow is equivalent to the current and the pressure to the voltage. The parameter (F−1)U_{H} in the circuit is an acoustic flow sink which describes the use of acoustic power to pump heat through the regenerator.

The analysis of the electric circuit shown in FIG. 4B gives the expression of the acoustic flow U_{H} as functions of the pressure P and the acoustic components in the circuit. Formulas 1 illustrate the flow U_{H} of thermoacoustic device 50.

$$Formula 1$$

$${U}_{H} = p \frac{( - {C}_{r} {C}_{K} R {ω}^{2} + i ( {C}_{K} CL {ω}^{3} + {C}_{r} ω ) )}{( 1 + F ) - L ( {C}_{r} + {C}_{K} + C ( 1 + F ) ) {ω}^{2} - {iC}_{K} R ( - ω + L ( {C}_{r} + C ) {ω}^{3} )}$$

Where C_{K} is the spring constant. The spring constant may be optimized using formula 2.

$${C}_{Kopt} = \frac{- ( Cr + C ( 1 + F ) ) L {ω}^{2} + ( 1 + F )}{L {ω}^{2}} \qquad Formula 2$$

Where F is the temperature ratio across the core and L is the inertance of the thermoacoustic device. The first term in formula 2 is negative and relatively small. Therefore, C_{Kopt} is mostly determined by the second factor (1+F)/Lω²; where F is the temperature ration across the core and L is the inertance of the thermoacoustic device. It is noted that the preceding and following formulas are evaluated for the flow at the hot side of the regenerator U_{H}, but this is also true for U_{C} and all flows through the heat pump.

By contrast a thermoacoustic device without a partitioning element, such as the thermoacoustic device 100 of FIG. 1, produces a flow, where the flow is expressed by formula 3.

$${U}_{H} = - p \frac{( LC {ω}^{2} + {iRC}_{r} ω )}{[ ( {C}_{r} + C ) LR {ω}^{2} - R ] - iL ω} \qquad Formula 3$$

When comparing thermoacoustic devices with a partitioning element with thermoacoustic devices without a partitioning element, it is clear that the partitioning element reinforces the effect of the acoustic components. Comparing Formula 1 with Formula 3, shows how the acoustic flows are influenced by the introduction of the partitioning element in the system. The partitioning element reinforces the effect of the acoustic components as the different terms are multiplied by the spring constant (C_{K}) of the partitioning element. This has an important effect on the magnitude and phase of the flows within the thermoacoustic device. The aim is to increase the power density and to improve the Stirling cycle conditions in the regenerator. This can be done by optimizing the flows. The optimal C_{K} which maximizes the flows is given by the expression in Formula 2.

It is noted that more detail can be implemented in the impedance analogy to more accurately determine the spring constant. However, any further details do not have a substantial effect on the optimal value of the spring constant.

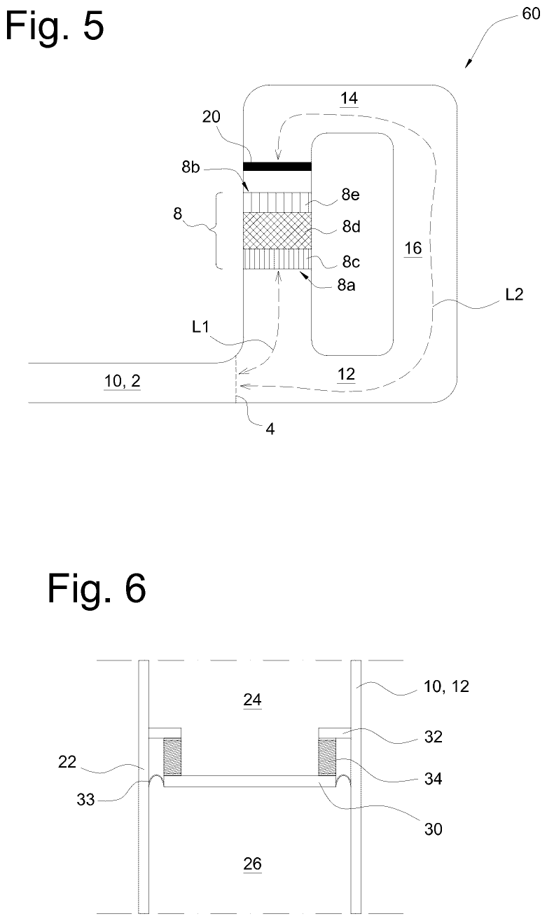

FIG. 5 shows a cross-section of a thermoacoustic device according to an embodiment of the invention.

In FIG. 5 entities with the same reference number as shown in the preceding FIGS. 1-4 refer to corresponding or similar entities.

According to the embodiment shown in FIG. 5, the spring-type partitioning element is arranged in the second leg of the loop near the second side of the thermoacoustic core, between the thermoacoustic core and the location of the compliance volume.

In this position the spring-type partitioning element still enhances the acoustic circuit in comparison with the acoustic circuit from the prior art

An optimal magnitude, as shown in Formula 3, of the spring constant of the spring-type partitioning element is depending on the acoustic parameters of the system (compliances, inertance, resistance of the regenerator) but also on the temperature ratio across the regenerator.

In a preferred position (as shown in FIG. 3), the magnitude of the spring constant of the spring-type partitioning element is mainly determined by the magnitude of the inertance and the temperature ratio across the regenerator as shown in Formula 2. Detailed analysis with thermoacoustic design software (e.g. Delta EC software) can be applied to determine an optimal spring constant value of the spring-type partitioning element.

Furthermore, since a zero-mass spring does not exist under practical circumstances, the magnitude of the spring constant of the spring-type partitioning element needs to be adjusted by taking the mass of the spring-type partitioning element 20 into account. The resonant spring constant (belonging to the mass of the spring-type partitioning element) has to be added to the optimal spring constant value of the zero-mass spring to obtain an optimal spring constant value for a spring-type partitioning element with a specific mass.

FIG. 6 shows a cross-section of a spring-type partitioning element 20 in accordance with an embodiment of the invention.

The spring-type partitioning element 20 according to this embodiment is designed to cover the cross-section of the first leg 10 or alternatively the cross-section of the second leg 12 of the loop and to attach entirely to the wall 22 of the respective leg portion at the level of the covered cross-section. In this manner, the first or second leg portion 10; 12 is divided in two sub-volumes 24, 26 separated from each other. The division prevents flow of the working fluid between the two sub-volumes, but at the same time allows transmission of pressure waves through the spring-type partitioning element 20 between the two sub-volumes.

As shown in FIG. 6, the spring-type partitioning element 20 comprises a central section 30 and an outer (annular) section 32 joined to a circumference of the central section by means of a spring or spring arrangement 34. The outer annular section 32 is to be attached to the wall 22 of the first leg portion 10 or alternatively the wall of the second leg portion 12. A flexible seal 33 is placed in the annular section to avoid gas flowing through the partitioning element.

Preferably the central section 30 has a planar shape, but could have a different shape, for example convex or concave.

According to an embodiment, the plane of the central section 30 is displaced in perpendicular direction relative to the level of outer section 32 of the spring-type partitioning element 20 with the spring or spring arrangement 34 located in between the levels of the central section 30 and the outer section 32. The spring or spring arrangement 34 is configured to allow movement of the central section 30 in a direction transverse to the plane of the outer section 32.

When the spring-type partitioning element 20 is mounted in the first (or second) leg portion, the central section 30 will be allowed to move in the direction parallel to the (local) length of the leg portion.

It is noted that in this embodiment, the spring-type partitioning element 20 has a shape that substantially matches of its location in the cross-section of the leg portion 10; 12, for covering and closing off the cross-section.

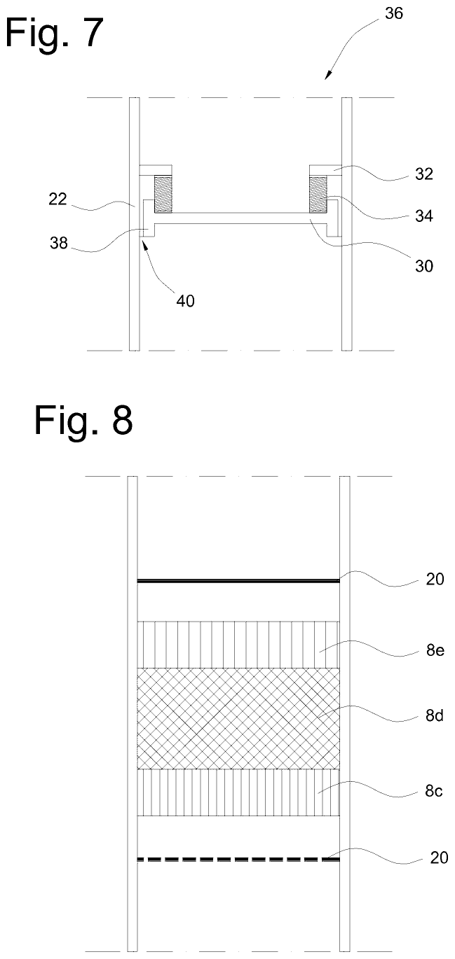

FIG. 7 shows a cross-section of a spring-type partitioning element 36 in accordance with an embodiment of the invention.

In FIG. 7 entities with the same reference number as shown in the preceding FIG. 6 refer to corresponding or similar entities.

The spring-type partitioning element 36 according to this embodiment is similar to the spring-type partitioning element 20 shown in FIG. 6, and further comprises a collar shaped edge portion 38 that is attached around the circumference of the central section 30 of the spring-type partitioning element. A gap seal 40 is arranged between the edge portion and the wall 22 of the leg portion to improve the barrier function for closing off flow of the pressurized gas across the spring-type partitioning element.

FIG. 8 shows a cross-section of a spring-type partitioning element consisting of an elastic membrane in accordance with an embodiment of the invention. The elastic membrane is tensioned in radial direction and closes of the cross section. The acoustic wave periodically stretches and deflects the membrane in the transverse direction.

The type and thickness of the elastic material of the membrane is chosen such that the membrane obtains the correct spring constant.

The membrane has a stiffness that is significantly higher compared to the stiffness of a latex membrane which usually is used to block DC-flow. The required stiffness of the membrane depends on the system design (i.e. size of the system) and the operational conditions (i.e. system pressure). For relatively small systems with typical diameter of 0.07 m a silicon rubber type of membrane with a thickness of 0.5 mm could be used as partitioning element.

The invention has been described with reference to some embodiments. Obvious modifications and alterations will occur to the skilled in the art upon reading and understanding the preceding detailed description.

In addition, modifications may be made to adapt a particular layout or a material to the teachings of the invention without departing from the scope thereof. In particular, combinations of specific features of various aspects of the invention may be made. An aspect of the invention may be further advantageously enhanced by adding a feature that was described in relation to another aspect of the invention.

Therefore, it is intended that the invention not be limited to the particular embodiments disclosed, but that the invention includes all modifications insofar as they come within the scope of the appended claims.

1. A thermoacoustic device for transfer of energy by an acoustic wave, the device comprising:
a tube filled with a working fluid, wherein the tube is in the shape of a loop configured with a passage, wherein the tube is configured as an acoustic circuit including a compliance volume, an inertance volume, and a thermoacoustic core, wherein the working fluid has a first volume flow; and
a partitioning element positioned in the tube to prevent the working fluid from flowing past the partitioning element,
wherein the partitioning element includes a spring constant value, wherein the spring constant value is based on the inertance volume and a temperature ratio across the thermoacoustic core,
wherein a material of the partitioning element is chosen to achieve the spring constant value,
wherein the partitioning element transmits pressure waves in the working fluid from a first end of the partitioning element in response to receiving an acoustic wave on a second end of the partitioning element.

2. The thermoacoustic device according to claim 1, wherein the partitioning element is a membrane having a thickness, wherein the spring constant value is based on the thickness of the membrane.

3. The thermoacoustic device according to claim 2, wherein the thickness of the membrane is further based on a diameter of the tube.

4. The thermoacoustic device according to claim 3, wherein the membrane is formed from Viton rubber.

5. The thermoacoustic device according to claim 3, wherein a ratio of the diameter of the tube to the thickness of the membrane is up to 14:1.

6. The thermoacoustic device according to claim 1, wherein the partitioning element comprises any one of a cylindrical spring, a conical spring, a wave spring, or a flexure bearing.

7. The thermoacoustic device according to claim 1, wherein the partitioning element is arranged at a predetermined position between the thermoacoustic core and the passage.

8. The thermoacoustic device according to claim 1, wherein the partitioning element is arranged between a first side of the thermoacoustic core and the passage.

9. The thermoacoustic device according to claim 1, wherein the partitioning element is arranged between a second side of the thermoacoustic core and the passage.

10. The thermoacoustic device according to claim 7, wherein a distance between the partitioning element and the second side of the thermoacoustic core is relatively shorter than a distance between the partitioning element and the passage.

11. The thermoacoustic device according to claim 1, wherein the spring constant is determined by the following formula:
$${C}_{Kopt} = \frac{- ( Cr + C ( 1 + F ) ) L {ω}^{2} + ( 1 + F )}{L {ω}^{2}}$$
where F is the temperature ratio across the thermoacoustic core and L is the inertance volume of the thermoacoustic device.
